(19) United States
(12) Patent Application Publication
(10) Pub. No.: US 2008/0191630 A1
(43) Pub. Date: Aug. 14, 2008

(54) SYSTEMS AND METHODS FOR IMPROVED ILLUMINATION ELECTRICAL SWITCHING

(76) Inventor: Robin Peng, South Jordan, UT (US)

Correspondence Address: GEOFFREY E. DOBBIN, PATENT ATTORNEY, 4278 SOUTH 6220 WEST, WEST VALLEY CITY, UT, 84128-6501, US

(21) Appl. No.: 11/832,539

(22) Filed: Aug. 1, 2007

Related U.S. Application Data
(60) Provisional application No. 60/820,971, filed on Aug. 1, 2006.

(51) Int. Cl. H05B 37/02

(52) U.S. Cl. 315/158

(57) ABSTRACT

The present invention relates to systems and methods for improved illumination electrical switching. One embodiment of the present invention relates to a system for electrically switching an illumination device in response to detected motion and/or natural light level in a manner that complies and/or exceeds the energy conservation requirements of California Title 24. The system is configured to switch on when a particular motion is detected and includes the ability to selectively adjust the intensity of the light output based on the detected existing natural light level. A second embodiment of the present invention relates to a method for electrically switching an illumination device in response to a detected light intensity. A third embodiment of the present invention relates to a method for electrically switching an illumination device in response to detected motion.

### CROSS-REFERENCES TO RELATED APPLICATIONS

This application claims priority on prior filed U.S. Provisional Application 60/820,971, filed Aug. 1, 2006 and incorporates the same by reference in its entirety.

### FIELD OF THE INVENTION

The invention generally relates to systems and methods for improved illumination electrical switching. In particular, the present invention relates to a system for controlling an illumination device in response to a detected input.

### BACKGROUND OF THE INVENTION

Electrical devices require electricity for power. Since electricity is finite it is generally desirable to minimize usage in order to minimize expenses and environmental impacts. For this reason, intelligent electrical switching technologies have become increasingly important for device operation that conserves power usage. Conventional toggle switches and buttons allow a user to switch on or off a device through a particular manual operation. Unfortunately, these conventional switches require a user to manually turn off a device often resulting in excess electricity usage. Various types of intelligent switches attempt to predict times when a user would intend for a device to be switched off. These intelligent switches include motion sensors that automatically switch on or off an electrical device depending on whether motion is detected within a particular region. Various intelligent switches exist based on other parameters, including pressure, thermal, timer, etc. For certain applications, intelligent switching has become mandatory. For example, California has enacted Title 24 to require certain intelligent energy conservation features on all new residential and commercial electrical switches.

Unfortunately, many of the intelligent switches currently on the market fail to accurately predict when a user would like to switch on or off a device. Switching on or off a device at an undesirable time may be referred to as an error, and the error rate of these switches is high in certain situations. For example, conventional motion sensors erroneously switch on devices when animals or bugs move within the sensors area. Likewise, few intelligent switches incorporate dimmers to selectively switch on a device at a particular intensity or level.

Therefore, there is a need in the industry for systems and methods related to intelligent electrical switching that both minimize errors and incorporate energy saving attributes such as selective dimming.

### SUMMARY OF THE INVENTION

The present invention relates to systems and methods for improved illumination electrical switching. One embodiment of the present invention relates to a system for electrically switching an illumination device in response to detected motion and/or natural light level in a manner that complies and/or exceeds the energy conservation requirements of California Title 24. The system is configured to switch on when a particular motion is detected and includes the ability to selectively adjust the intensity of the light output based on the detected existing natural light level. The system includes a power source, an electrical illumination device, a sensor, a processor, and a dimming switch. The power source may be a residential AC power supply commonly used to supply power to light fixtures. The electrical illumination device may be a residential light fixture such as a halogen lamp. The sensor may include a photocell for detecting light intensity and/or a detection device for detecting motion. The dimming switch may be any switching device capable of providing varying amounts of current to a device. A second embodiment of the present invention relates to a method for electrically switching an illumination device in response to a detected light intensity. The method includes receiving an optical input, identifying natural light intensity within an area, and switching on an illumination device so as to generate artificial light necessary to make the combined natural and artificial light intensity equal to a preset value. The preset light intensity value may be an intensity determined to be sufficient for an individual to read. A third embodiment of the present invention relates to a method for electrically switching an illumination device in response to detected motion. The method includes receiving an optical input, identifying motion within an area, determining if the motion is human-generated motion that necessitates switching, and switching on an electrical illumination device if the motion is determined to be human-generated motion that necessitates illumination. Human-generated motion that necessitates illumination includes motion lasting a minimum duration and over a minimum region.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. The Figures presented in conjunction with this description are views of only particular—rather than complete—portions of the systems and methods of making and using the port system according to the invention. In the Figures, the physical dimensions may be exaggerated for clarity. The same reference numerals in different drawings represent the same element, and thus their descriptions will be omitted.

FIG. 1 illustrates a system in accordance with one embodiment of the present invention;

FIG. 2 illustrates a method in accordance with a second embodiment of the present invention;

FIG. 3 illustrates a method in accordance with a third embodiment of the present invention; and

FIG. 4 illustrates a light intensity chart illustrating balancing natural and artificial light in accordance with embodiments of the present invention.

### DETAILED DESCRIPTION OF THE INVENTION

The present invention relates to systems and methods for improved illumination electrical switching. One embodiment of the present invention relates to a system for electrically switching an illumination device in response to detected motion and/or natural light level in a manner that complies and/or exceeds the energy conservation requirements of California Title 24. The system is configured to switch on when a particular motion is detected and includes the ability to selectively adjust the intensity of the light output based on the detected existing natural light level. The system includes a power source, an electrical illumination device, a sensor, a processor, and a dimming switch. The power source may be a residential AC power supply commonly used to supply power to light fixtures. The electrical illumination device may be a residential light fixture such as a halogen lamp. The sensor may include a photocell for detecting light intensity and/or a detection device for detecting motion. The dimming switch may be any switching device capable of providing varying amounts of current to a device. A second embodiment of the present invention relates to a method for electrically switching an illumination device in response to a detected light intensity. The method includes receiving an optical input, identifying natural light intensity within an area, and switching on an illumination device so as to generate artificial light necessary to make the combined natural and artificial light intensity equal to a preset value. The preset light intensity value may be an intensity determined to be sufficient for an individual to read. A third embodiment of the present invention relates to a method for electrically switching an illumination device in response to detected motion. The method includes receiving an optical input, identifying motion within an area, determining if the motion is human-generated motion that necessitates switching, and switching on an electrical illumination device if the motion is determined to be human-generated motion that necessitates illumination. Human-generated motion that necessitates illumination includes motion lasting a minimum duration and over a minimum region.

The following terms are defined as follows:

Illumination output device—any device capable of generating illumination including but not limited to light bulbs, LEDs, chemical lighting, etc.

Sensor—an optical sensing device configured to detect at least one value of light intensity, irradiance, motion, video, color, etc. Various sensor devices may be utilized, including photocells, CCD cameras, etc. The sensor may be configured to detect within a particular zone of operation such as a single room.

Dimming switch—an electrical switch capable of selectively adjusting the current level to a particular device. Various types of dimming circuits may be utilized.

Natural light—light originating from a natural source including but not limited to sunlight.

Artificial light—light originating from a non-natural source such as a light bulb or LED.

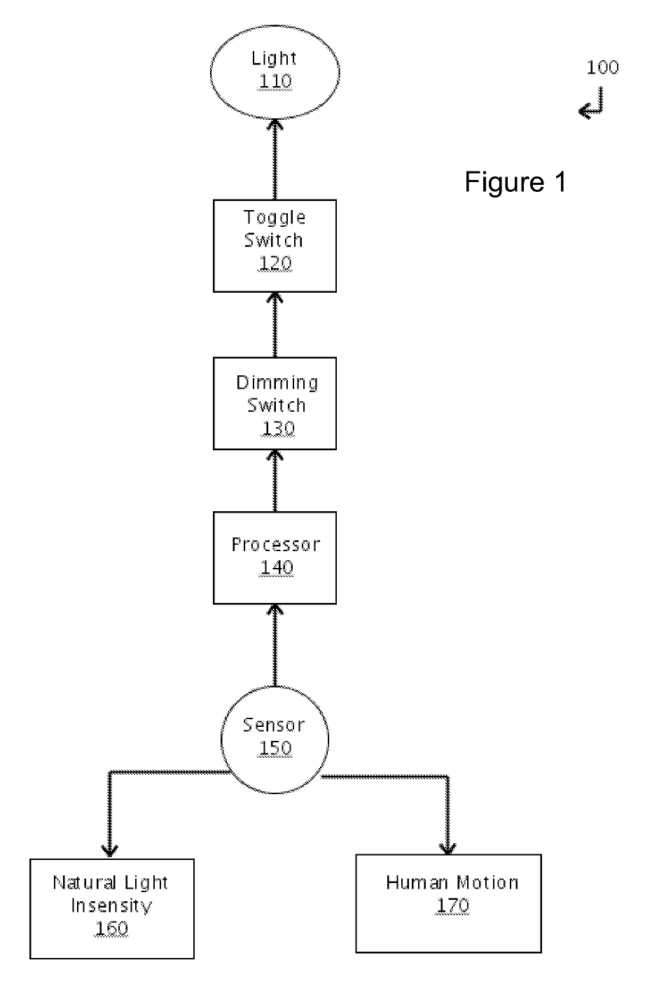

Reference is initially made to FIG. 1, which illustrates a system in accordance with one embodiment of the present invention, designated generally at 100. The system 100 is configured to switch on the light 110 in response to detecting human motion 170 and a particular natural light intensity 160. The system is designed to comply with all energy minimization standards including EnergyStar and California Title 24. The light 110 may include one or more illumination devices positioned in a particular region. The system includes a toggle switch 120, a dimming switch 130, a processor 140, and a sensor 150. The sensor 150 is configured to detect the natural light intensity 160 in a particular area. The particular area may be a room or region that the light 110 illuminates. The processor 140 analyzes the detected natural light intensity level 160 and determines if it is below a particular preset value. The preset value may be a light intensity level that is determined to be sufficient for a majority of activities. Alternatively or in addition, the preset value may be adjusted to accommodate specific needs. If the natural light intensity level 160 is below the preset value, the light in the particular area is not sufficient. The sensor 150 is also configured to detect human motion 170 within the particular area. The processor 140 determines if human motion is present by analyzing an optical input from the sensor 150 and selectively determining if changes in optical images (motion) are due to human motion. The processor 140 may be any type of microprocessor or computer that can be programmed to perform the necessary analysis. Various algorithms may be used for this purpose so as to eliminate erroneous motion detection that is caused by a non-human source such as a pet. If the processor 140 determines there is human motion 170 and the natural light intensity 160 is below the preset value, the processor 140 will cause the dimming switch 130 to selectively illuminate the light 110 to an intensity level that will cause the combined artificial and natural light intensity 160 to meet or exceed the preset value. The light 110 may only be illuminated if the toggle switch 120 is in the “on” position; therefore, the toggle switch 120 may be used to override the processor functionality by manually preventing electricity from being transmitted to the light 110 by switching to an “off” position. Although not illustrated, a power source is coupled to the dimming switch 130. The power source 130 may be a residential AC power source.

The toggle switch 120 may be a touchless digital switch that allows users to switch on or off the device without physically touching the switch. Various types of touchless switches may be used, including ones that specifically detect and electrically operate in a manner consistent with the physical movements that are required to physically switch a residential toggle bar switch. The system 100 may be appropriately sized so as to fit within a residential wall outlet receptacle box.

In addition, the system 100 may communicate with other systems for increased functionality. This communication may be manually initiated or dynamically identified (i.e. ad-hoc network). For example, if motion and low natural light is detected in a hallway system, a bedroom system may also be configured to switch on to predict that a user is likely to walk into the bedroom. Likewise, the systems may be networked together to allow central control and/or adjustment of the determined light level required, the sensor sensitivity, human motion, etc. Communication between the systems may be accomplished with a communication module, which may be added to the system illustrated in FIG. 1. The communication module may utilize wired or wireless communication technology.

The processor 140 may include additional functionality to automatically dim or turn off the light 110 if human motion 170 has not been detected within a particular time or if the natural light intensity 160 level rises to meet or exceed the preset value. Likewise, the processor 140 may be programmed to include times of day in which the switch requires a higher level of motion to activate the light. For example, it is unlikely a user would wish to turn on a light at night with the minimal motion that occurs during sleep. Alternatively, the processor 140 may default to switch the light 110 to an off state during certain times of day. The processor 140 may be programmed to record usage patterns and identify common cycles that could be utilized to further conserve energy. For example, if the user only requires minimal lighting during 8 am-9 am the determined light value may be adjusted accordingly. Various other functionalities may be incorporated into the system and remain consistent with the present invention, including but not limited to security, baby monitoring, peak/off-peak power consumption, etc.

An optional microphone (not depicted) may also be added to the system 100 to receive audible inputs from a user. The microphone would also be coupled to the processor 140 to further predict the needs of user and switch on the light 110 at times when it is necessary but minimize energy consumption by turning off the light when it is not needed. For example, the microphone could be used in conjunction with the sensor to allow the processor 140 to determine if identified motion within the area is human motion that necessitates illumination.

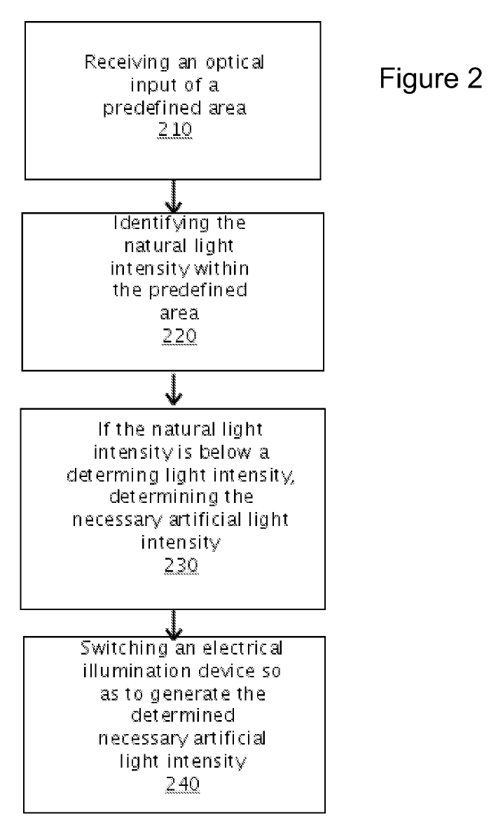

Reference is next made to FIG. 2, which illustrates a method in accordance with a second embodiment of the present invention. The method is used for selectively switching on an illumination device in response to a detected natural light intensity level. The method includes receiving an optical input for a predefined area, act 210. After the optical input is received, the optical input is analyzed to determine the natural light intensity within the predefined area is identified, act 220. If the identified natural light intensity is below a preset value, the necessary artificial light intensity to produce a combined artificial and natural light intensity equal to or greater than the preset value is determined, act 230. The electrical illumination device is switched on so as to generate the determined necessary artificial light intensity.

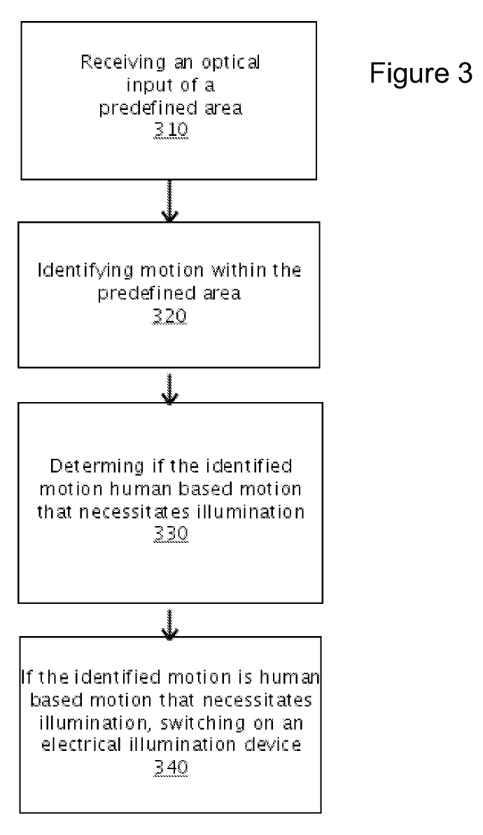

Reference is next made to FIG. 3, which illustrates a method in accordance with a third embodiment of the present invention. The method is for selectively switching on an illumination device in response to the detection of human motion. The method includes receiving an optical input of a predefined area, act 310. The received optical input is analyzed to identify if there is motion within the predefined area, act 320. The identification of motion may be accomplished by recognizing a difference in the optical input as a function of time. Various other motion identification schemes may be used depending on the type of optical input. The method then determines if the identified motion is human-generated motion that necessitates illumination, act 330. Various human motion detection algorithms may be utilized to distinguish human motion from other types of motion. In addition, various human motion characteristics may be utilized to determine if the human motion necessitates illumination. For example, the duration and range of the motion may be utilized in determining if illumination is necessary. If the identified motion is determined to be human-generated motion that necessitates illumination, the electrical illumination device is switched on, act 340.

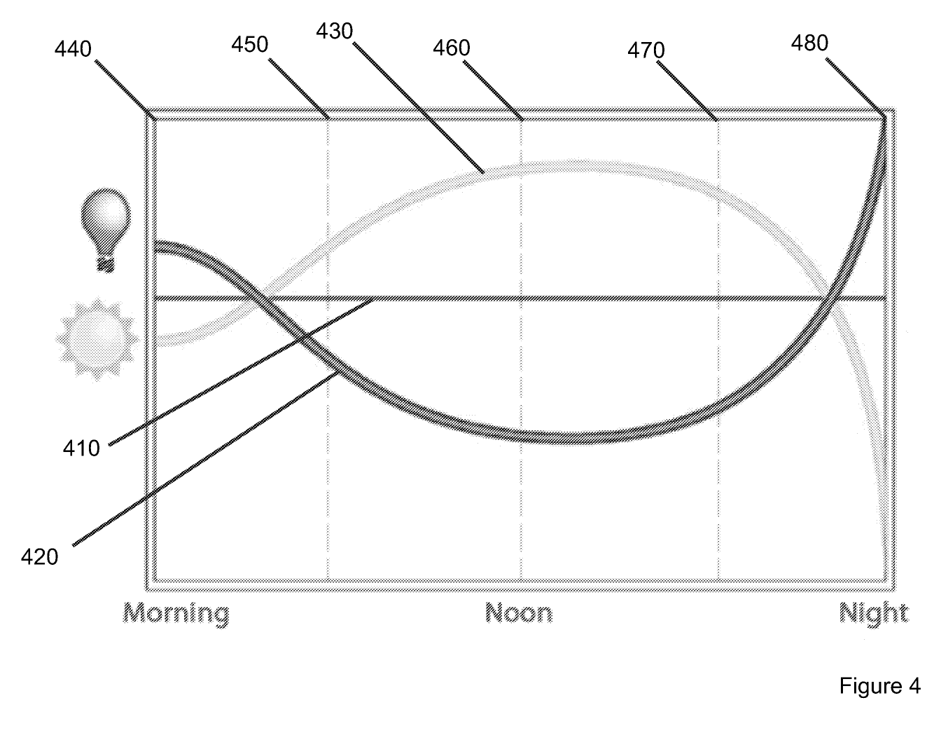

Reference is next made to FIG. 4, which illustrates a light intensity chart that balances natural and artificial light in accordance with embodiments of the present invention. In the chart, line 410 represents a level of minimum light intensity while line 420 represents the level of artificial illumination and line 430 represents natural ambient sunlight. Over time, a sensor determines ambient sunlight 430 in relation to the desired illumination level 410 and adjusts artificial illumination 420 accordingly. In the morning 440, sunlight 430 is below the desired level 410 and so the artificial light intensity 420 is increased. As the day progresses to late morning 450, sunlight 430 increases, causing a decrease in artificial lighting 420. The pattern continues through noon 460 and into late afternoon 470 when natural sunlight 430 begins to decrease. Eventually, at night 480, when there is no ambient sunlight 430, the artificial illumination 420 is turned on at maximum power. It should be noted that the desired light level 410 is a minimum lighting level, especially during the afternoon and late morning when the combined light from the sources is greater than the minimum level 410.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A system for electrically switching an illumination device comprising:
an electrical power source;
an illumination output device;
a sensor configured to detect at least one of motion and ambient light intensity within a predefined area;
a processor configured to analyze the detected information from the sensor and determine if the detected data indicates that there is at least one human motion within the predefined area and that the natural light intensity is below a determined light intensity; and
an electrical dimming switch coupled to the electrical power source, illumination output device, and the processor,
wherein if the processor determines that there is human motion within the predefined area and that the natural light intensity is below the determined light intensity, routing electricity from the electrical power source to the illumination output device so as to generate an artificial light intensity which in combination with the natural light intensity equals at least the determined light intensity.

2. The system of claim 1 further including a toggle switch that includes an off state and an on state, wherein if the toggle switch is in the off state, the system is turned off.

3. A method for electrically switching an illumination device in response to a detected light intensity, comprising the acts of: receiving an optical input of a predefined area;
identifying the natural light intensity within the predefined area;
if the natural light intensity is below a determined light intensity, determining the necessary artificial light intensity such that the combined natural and artificial light intensity is equal to or greater than the determined light intensity;
activating an electrical illumination device so as to generate the determined necessary artificial light intensity.

4. The method of claim 3 wherein, the act of activating the electrical illumination device includes routing electricity to the electrical illumination device through a dimming switch with a particular impedence level so as to generate the determined necessary artificial light intensity.

5. The method of claim 3 further comprising the step of regularly monitoring ambient light intensity and adjusting artificial light intensity to meet a preset ambient light value accordingly.

6. The method of claim 3 further comprising the step of recording usage patterns and utilizing said usage patterns to determine needed light intensity.

7. A method for electrically switching an illumination device in response to detected motion, comprising the acts of:
receiving an optical input of a predefined area;
identifying motion within the predefined area;
determining if the motion is human-generated motion that necessitates illumination; and
if the identified motion is human-generated motion that necessitates illumination, activating an electrical illumination device;
wherein human-generated motion that necessitates illumination includes motion both lasting a minimum duration and over a minimum region.

8. The method of claim 7 further including if human-generated motion that necessitates illumination is not identified within a specific time period, deactivating the electrical illumination device.

9. The method of claim 7, further comprising the act of adjusting the determination of human-generated motion that necessitates illumination according to time of day.

10. The method of claim 7, further comprising the acts of sensing ambient light, determining if the ambient light is below a minimum threshold, and, if necessary, activating the electrical illumination device in a manner that provides only enough light to meet the minimum threshold of ambient light.

11. The method of claim 7, further comprising the acts of sensing ambient light, determining if the ambient light is below a minimum threshold, and, if necessary, activating the electrical illumination device in a manner that provides enough light to exceed the minimum threshold of ambient light within a preset range of acceptable light.

12. The method of claim 7, the act of determining human generated motion that necessitates illumination being done by also utilizing analysis of ambient sound.

13. The method of claim 7, the act of determining human generated motion that necessitates illumination being done by also utilizing analysis of time of day.
